(19) United States
(12) Patent Application Publication
(10) Pub. No.: US 2014/0276280 A1
(43) Pub. Date: Sep. 18, 2014

(54) MASSAGE DEVICE

(71) Applicant: Rafael J. OLLER, JR., Studio City, CA (US)

(72) Inventor: Rafael J. OLLER, JR., Studio City, CA (US)

(21) Appl. No.: 13/840,740

(22) Filed: Mar. 15, 2013

(51) Int. Cl. A61H 7/00

(52) U.S. Cl. CPC A61H 7/003
USPC 601/138

(57) ABSTRACT

A massage device is provided having a pouch formed from a flexible material, a pair of resilient bodies received within the pouch, the pair of resilient bodies being made from rubber having a moisture content and at least two straps coupled to opposite ends of the pouch, the at least two straps having a predetermined length. The flexible material may include an elastic fabric, such as nylon or cotton. The pair of resilient bodies may include at least one of a same size, a same shape, and a same texture. Furthermore, the pair of resilient bodies may be made from various rubber materials having a Young's modulus of between 0.1 and 10 ksi. The pair of resilient bodies may include air pockets having moisture that is heated by microwave energy. Alternatively, the pair of resilient bodies may include a battery operated heating element and a vibration device.

### FIELD OF THE INVENTION

This disclosure relates generally to a massage device configured to apply heat and pressure to selected areas of a human body and more specifically, the disclosure provides a therapeutic massage device having a pair of heat emitting resilient balls positioned within a flexible container.

### BACKGROUND

Massage therapy is a known technique for soothing tension-related ailments and muscular discomfort by applying pressure to targeted areas of the body. Applying pressure alleviates soreness and pain, promotes blood circulation, and releases blocked energy along the body's energy channels. Known massage devices include resilient balls for applying pressure to various parts of a human body. However, there is a need for a massage device that applies heat, pressure, and is freely positioned on the neck, shoulders, and back.

### SUMMARY OF THE INVENTION

This disclosure provides a massage device that is inexpensive to manufacture and offers beneficial results. The disclosure provides a therapeutic massage device that includes a flexible pouch for holding a pair of resilient bodies adapted to provide targeted heat and pressure to selected parts of a user's body in order to sooth tension-related ailments. The resilient bodies contain moisture and may be heated using microwave energy or the like. Alternatively, the resilient bodies may include a heating element.

The massage device soothes a wide range of muscles, including sore muscles, acupressure points, and trigger points. Trigger points, also known as trigger sites or muscle knots, are small muscle contractions that can induce local as well as referred pain and require at times highly targeted massage. Trigger point massage is recognized as an effective modality used by massage therapists for the relief of pain. When applying therapeutic massage to trigger points, one presses and holds the trigger point for a few seconds or until the trigger point “releases”. This is known as ischemic compression, where fluid and blood are literally squeezed out of the tissue to remove toxins and increase therapeutic blood flow. The pressure required for this type of massage may risk overworking the hands and fingers while performing self-applied massage. The massage device avoids this potentially hazardous strain on the hands and enables the user to work on a wider range of muscles. Specifically, the massage device may be applied to accurately pinpoint and work on individual trigger points, sore muscles and acupressure points most anywhere on the body. Adding heat to the area through the massage device accelerates blood flow and helps to soften and stretch tissue. The pleasurable warming sensation applied during the massage contributes to longer and more effective self-applied massage sessions.

### BRIEF DESCRIPTION OF THE DRAWINGS

Features of the disclosure, including both structural features and operational elements, will be more readily appreciated and understood by reviewing the accompanying drawings in conjunction with the accompanying description, in which similar reference characters refer to similar parts, and in which:

FIG. 1 illustrates a perspective view of the massage device applied to a middle-back section while in a standing position against a wall according to one example of the disclosure;

FIG. 2 illustrates a perspective view of the massage device applied to a back area while in a standing position against a wall according to one example of the disclosure;

FIG. 3 illustrates a perspective view of the massage device applied to a shoulder area section while in a standing position against a wall according to one example of the disclosure;

FIG. 4 illustrates a perspective view of the massage device according to one example of the disclosure, the massage device being depicted with a portion of a pouch cut away;

FIG. 5 illustrates a cross-sectional view of the massage device taken along line 3-3 shown in FIG. 4 according to one example of the disclosure;

FIG. 6 illustrates a cross-sectional view of a resilient body having a heating element, a vibration device, or both, according to one example of the disclosure; and

FIG. 7 illustrates a perspective view of the massage device having an adjustable strap according to one example of the disclosure.

### DETAILED DESCRIPTION

FIG. 1 illustrates an example massage device 10 that may be used to sooth tension-related ailments. The massage device 10 includes a pouch 11, loops 12, straps 14, and resilient bodies (illustrated in FIG. 4) contained within the pouch 11. The massage device 10 is shown gripped by a user's outstretched arms using the loops 12 formed from the straps 14. According to one example, each strap 14 may include a length in a range of 1 foot to 3 feet. During use, the massage device 10 may be positioned between a user's body 16 and a surface, such as a wall 15, floor, or the like. The user's body 16 may be oriented in a laying or standing position. According to one example, the user may press his or her back toward the wall 15 to apply pressure against the pouch 11. The user may control an amount of pressure exerted on the massage device 10 by adjusting a distance between the wall 15 and his or her feet. For example, the user may position his or her feet close to the wall 15 to decrease pressure exerted on the massage device 10. Alternatively, the user may position his or her feet away from the wall 15 to increase pressure exerted on the massage device 10.

According to one example, the user may press her neck, shoulders, or back toward the wall 15 to apply pressure against the pouch 11. The user may move her neck, shoulders, or back up and down, sideways, and diagonally relative to the massage device 10 to obtain the desired massaging effect. The user may selectively reposition the massage device 10 along various portions of the neck, shoulders, or back to apply acupressure therapy. It can be appreciated that the massage device 10 is configured with loops 12 and straps 14 for use by an individual without assistance from another. One of ordinary skill in the art will readily appreciate that the massage device 10 may be used to massage other portions of a body. For example, the massage device 10 may be positioned to massage a leg, side torso, or the like. One of ordinary skill in the art will readily appreciate that other massage techniques may be utilized. For example, FIG. 2 illustrates that the massage device may be positioned vertically and horizontally along a user's back by manipulating the loops 12 and the straps 14 as desired between a user's body 16 and a surface, such as the wall 15. For example, FIG. 3 illustrates that the massage device may be positioned along a user's shoulders by manipulating the loops 12 and the straps 14 as desired between a user's body 16 and a surface, such as the wall (not shown).

Referring now to FIG. 4, the pouch 11 may be formed from a flexible material such as an elastic fabric including nylon, spandex, cotton, or the like. The pouch 11 may be constructed by folding and sewing the flexible material. For example, the flexible material may be cut into a desired shape, such as a rectangular shape. The flexible material may be folded and sewn together to form a seam that encloses the pouch 11. The pouch 11 may be constructed from a fabric sheet having a length of between 10 to 12 inches and a width of between 4 to 6 inches. One of ordinary skill in the art will readily appreciate that the pouch 11 may be constructed from a fabric sheet of various sizes and shapes depending upon a size and shape of the resilient bodies 21a, 21b enclosed therein.

The pouch 11 may be configured to receive two resilient bodies 21a, 21b therein. The resilient bodies 21a, 21b may include substantially similar characteristics, such as a same diameter, a same shape, a same material, or the like. Alternatively, the resilient bodies 21a, 21b may include different characteristics, such as a different diameter, a different shape, and a different material. The resilient bodies 21a, 21b may be selected to include any desired characteristics, such as shape, size, texture, heat, vibration, or the like. The pouch 11 may be sized to snuggly receive the resilient bodies 21a, 21b, while providing sufficient space to permit lateral displacement or movement of the resilient bodies 21a, 21b relative to one another.

According to one example, the resilient bodies 21a, 21b may include a pair of solid rubber masses. For example, the resilient bodies 21a, 21b may be made from rubber including natural rubber, acrylic rubber, neoprene rubber, buna-N rubber, EPDM rubber, natural gum rubber, natural latex rubber, vinyl rubber, santoprene rubber, butyl rubber, TPE rubber, hypalon rubber, chlorinated polyethylene, epichlorhydrin rubber, ethylene propylene rubber, hydrogenated nitrile rubber, perfluoro elastomers, polynorbornene rubber, polyurethane rubber, styrene butadiene rubber, butadiene rubber, chlorobutyl, chlorosulphonated polyethylene, ethylene acrylic, fluoroelastomers, isoprene rubber, nitrile rubber, polychloroprene rubber, polysulphide rubber, tetra-flouroethylene/propylene rubber, or the like. According to one example, the Young's modulus of the resilient bodies 21a, 21b may in a range of 0.1-10.0 ksi.

FIG. 5 illustrates the resilient bodies 21a, 21b in cross-section. The resilient bodies 21a, 21b may include a solid core and may be formed from rubber that resists being deformed when subjected to compression forces. The resilient bodies 21a, 21b may be configured to have moisture content in a range of 0.01-80% wet-basis, where wet-basis moisture content is defined as the ratio of moisture mass to the total mass of a substance.

The resilient bodies 21a, 21b may be configured to include air pockets 42. According to one example, the air pockets 42 may retain a substantial portion of the moisture. The moisture content facilitates heating the resilient bodies 21a, 21b using microwave energy or the like. For example, microwave energy may be employed to transmit microwave radiation through the resilient bodies 21a, 21b. The microwave radiation may be non-ionizing microwave radiation. According to one example, the microwave radiation may be transmitted at a frequency of 2.45 GHz. The water content within the resilient bodies 21a, 21b may be configured to absorb the microwave energy. Once heated, the resilient bodies 21a, 21b may emit heat for a prolonged amount of time to provide heat and pressure therapy. According to one example, resilient bodies 21a, 21b may have a moisture content in the range of 0.1-0.5% wet-basis. The pouch 11 or resilient bodies 21a, 21b may further include a moisture retaining membrane that prevents water evaporation from repeated heating.

According to an alternative example illustrated in FIG. 6, a resilient body 41 may include a heating element 42, a vibration device 43, or both, powered by a battery 45. In this embodiment, the resilient body 41 may not be subjected to microwave energy. The pouch 11 may include a slit or other opening (not shown) that grants access to the resilient body 41 as needed to permit replacement of the battery 45. The slit or opening may include a zipper, loop and hook fasteners, laces, or other structures (not shown) to secure the resilient body 41 within the pouch 11.

During use, the resilient bodies 21a, 21b, 41 may be laterally adjusted within the pouch 11 relative to each other. In this way, the resilient bodies 21a, 21b, 41 may be laterally positioned as desired. For example, the resilient bodies 21a, 21b, 41 may be laterally positioned and aligned to straddle a user's spine while providing acupressure to muscles and soft tissue adjacent to the spine. For example, the user may position one resilient body 21a against muscle located on one side of the spine and may position a second resilient body 21b on muscle located on another side the spine. The resilient bodies 21a, 21b may be adjusted between an outermost position relative to each other and an innermost position relative to each other. Additionally, the user may move his or her neck, shoulders, or back up and down, sideways, and diagonally relative to the massage device 10 to target surrounding muscle or soft tissue area. To enhance therapeutic results, the resilient bodies 21a, 21b may be replaced with the resilient body 41 having a heating element 42, a vibration device 43, or both.

According to one example illustrated in FIG. 7, the strap 14 may pass through a buckle 22 to allow adjusting a length of the strap 14. The strap 14 has an adjustable length to accommodate different arm lengths. The straps 14 may be physically coupled to the pouch 11 at one end. For example, the straps 14 may be sewn directly to the pouch 11. The straps 14 may be folded and stitched together to form the loops 12 provided on ends of the strap 14 opposite to the pouch 11. The loops 12 provide handles that may be grasped by a user to position the pouch 11 and the resilient bodies 21a, 21b as desired. The strap 14 may be made from an elastic material such as nylon or the like.

The various examples described and illustrated herein are non-limiting examples. To this end, one of ordinary skill in the art will readily appreciate that numerous modifications and changes may be made after reading this disclosure. The invention is only limited by the spirit and scope of the appended claims.

I claim:

1. A massage device, comprising:
a pouch formed from a flexible material;
a pair of resilient bodies received within the pouch, the pair of resilient bodies being made from rubber having a moisture content; and
at least two straps coupled to opposite ends of the pouch, the at least two straps having a predetermined length.

2. The massage device of claim 1, wherein the flexible material includes an elastic fabric comprising at least one of nylon or cotton.

3. The massage device of claim 1, wherein the pair of resilient bodies include at least one of a same size, a same shape, and a same texture.

4. The massage device of claim 1, wherein the pair of resilient bodies include at least one of a different size, a different shape, or a different texture.

5. The massage device of claim 1, wherein the pair of resilient bodies may be made from at least one of natural rubber, acrylic rubber, neoprene rubber, buna-N rubber, EPDM rubber, natural gum rubber, natural latex rubber, vinyl rubber, santoprene rubber, butyl rubber, TPE rubber, hypalon rubber, chlorinated polyethylene, epichlorhydrin rubber, ethylene propylene rubber, hydrogenated nitrile rubber, perfluoro elastomers, polynorbornene rubber, polyurethane rubber, styrene butadiene rubber, butadiene rubber, chlorobutyl, chlorosulphonated polyethylene, ethylene acrylic, fluoroelastomers, isoprene rubber, nitrile rubber, polychloroprene rubber, polysulphide rubber, and tetra-flouroethylene/propylene rubber.

6. The massage device of claim 1, wherein the pair of resilient bodies include a Young's modulus of between 0.1 and 10 ksi.

7. The massage device of claim 1, wherein the pair of resilient bodies include a solid core.

8. The massage device of claim 1, wherein the pair of resilient bodies include air pockets.

9. The massage device of claim 8, wherein the air pockets are configured to retain moisture and the moisture content of the resilient bodies is between 0.1-0.5% wet-basis.

10. The massage device of claim 8, wherein the at least two straps include end portions having a loop.

11. The massage device of claim 1, wherein at least one strap includes a buckle.

12. The massage device of claim 1, wherein the pair of resilient bodies include at least one of a heating element and a vibration device.

13. A massage device, comprising:
a pouch formed from a flexible material;
a pair of resilient bodies received within the pouch, the pair of resilient bodies being made from rubber having a moisture content and a Young's modulus of between 0.1 and 10 ksi; and
at least two straps coupled to opposite ends of the pouch, the at least two straps having a predetermined length.

14. The massage device of claim 13, wherein the flexible material includes an elastic fabric comprising at least one of nylon or cotton.

15. The massage device of claim 13, wherein the pair of resilient bodies include at least one of a same size, a same shape, and a same texture.

16. The massage device of claim 13, wherein the pair of resilient bodies include at least one of a different size, a different shape, or a different texture.

17. The massage device of claim 13, wherein the pair of resilient bodies may be made from at least one of natural rubber, acrylic rubber, neoprene rubber, buna-N rubber, EPDM rubber, natural gum rubber, natural latex rubber, vinyl rubber, santoprene rubber, butyl rubber, TPE rubber, hypalon rubber, chlorinated polyethylene, epichlorhydrin rubber, ethylene propylene rubber, hydrogenated nitrile rubber, perfluoro elastomers, polynorbornene rubber, polyurethane rubber, styrene butadiene rubber, butadiene rubber, chlorobutyl, chlorosulphonated polyethylene, ethylene acrylic, fluoroelastomers, isoprene rubber, nitrile rubber, polychloroprene rubber, polysulphide rubber, and tetra-flouroethylene/propylene rubber.

18. The massage device of claim 13, wherein the pair of resilient bodies include air pockets.

19. The massage device of claim 13, wherein the pair of resilient bodies include a solid core and the moisture content is between 0.1-0.5% wet-basis.

20. The massage device of claim 13, wherein the pair of resilient bodies include at least one of a heating element and a vibration device.
